(19) United States
(12) Patent Application Publication
(10) Pub. No.: US 2024/0367373 A1
(43) Pub. Date: Nov. 7, 2024

(54) METHOD OF MANUFACTURING A COMPOSTABLE BREWABLE BEVERAGE POD

(71) Applicant: Keurig Green Mountain, Inc., Burlington, MA (US)

(72) Inventor: Francis James Coe, Lexington, MA (US)

(73) Assignee: Keurig Green Mountain, Inc., Burlington, MA (US)

(21) Appl. No.: 18/651,877

(22) Filed: May 1, 2024

Related U.S. Application Data
(60) Provisional application No. 63/500,221, filed on May 4, 2023.

(51) Int. Cl. B29C 64/165; B29C 64/291; B33Y 10/00; B33Y 30/00; B33Y 70/00; B33Y 80/00; B65D 85/804

(52) U.S. Cl. CPC B29C 64/165; B29C 64/291; B65D 85/8046; B33Y 10/00; B33Y 30/00; B33Y 70/00; B33Y 80/00

(57) ABSTRACT

Aspects disclosed herein related to a method of manufacturing a beverage pod that comprise loading successive layers of a beverage material, such as coffee, onto a print bed of a three-dimensional (3-D) printer. A binder is then applied to each of the successive layers of beverage material in a predetermined pattern to bond the beverage material in the predetermined pattern. The predetermined pattern corresponds to a sequential cross-sectional layer of an object model of the beverage pod where the object model describes sequential cross-sectional layers of the beverage pod designed based on a plurality of different brewing attributes.

### CROSS REFERENCE TO RELATED APPLICATION

This application claims the benefit of U.S. Provisional Application No. 63/500,221, filed May 4, 2023, which is hereby incorporated by reference in its entirety.

### FIELD

Disclosed embodiments are directed to manufacturing beverage pods for use in forming beverages.

### BACKGROUND

Pods composed of beverage ingredients can be used for forming a beverage. The form and function of pods may vary from single-serve cartridges, capsules, tablets, encapsulated balls or other packages containing or made from a portion of coffee or other beverage precursor base that is compatible with a coffee-making or other beverage-making appliance. In some arrangements, such beverage pods are mixed directly with hot water to form a beverage. In some arrangements, the pods may be designed with a containment layer to be pierced during the brewing process. In some arrangements, water is permitted to percolate through beverage pods to form a beverage.

Pods may be manufactured by packaging preformed capsules with beverage materials and sealing them with lid. In some arrangements, beverage tablets may be formed through the process of compacting beverage material under high pressure.

### SUMMARY

According to aspects discussed herein, a method of manufacturing a beverage pod may comprise loading successive layers of a beverage material, such as coffee grounds, onto a print bed of a three-dimensional (3-D) printer. A binder is then applied to each of the successive layers of beverage material in a predetermined pattern to bond the beverage material in the predetermined pattern, and the binder bonding the successive layers in the predetermined pattern. The predetermined pattern corresponds to a sequential cross-sectional layer of an object model of the beverage pod where the object model describes sequential cross-sectional layers of the beverage pod designed based on a plurality of different brewing attributes.

### BRIEF DESCRIPTION OF DRAWINGS

FIG. 1A is an embodiment of a 3-D printing system that may be used to manufacture a beverage pod;

FIG. 1B is another embodiment of a 3-D printing system that may be used to manufacture a beverage pod;

FIG. 1C is another embodiment of a 3-D printing system that may be used to manufacture a beverage pod;

FIGS. 2A-2G illustrate exemplary steps in a process of manufacturing a compostable pod in a 3-D printing system;

FIGS. 3A-3D are embodiments of beverage pods that may be manufactured in a 3-D printing system, including illustrations of the cross-sectional layers of each pod; and

FIG. 4 is a print bed illustrating multiple beverage pods printed in a build container.

### DETAILED DESCRIPTION

It should be understood that aspects of the invention are described herein with reference to the figures, which show illustrative embodiments. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

It is well known to provide beverage material in single serving beverage pods, including in a compacted tablet form. Beverage pods are commonly provided in individual packages and used with associated beverage machines to form a beverage.

These beverage machines and single serving packages may allow a user to prepare a small quantity of a beverage, such as a single serving. Multiple users can use the same machine to prepare different beverages, such as individual servings of different beverage types or beverage flavors quickly and without wasting unconsumed beverage. Single serving or small batch beverage machines may receive individual serving packages of beverage material, such as ground coffee, to be combined with liquid and brewed. These individual packages of beverage material may then be disposed after the beverage has been prepared.

The inventors have recognized and appreciated improvements in beverage material packaging, beverages machines, and methods of forming a beverage. These improvements may reduce beverage material packaging and/or waste resulting from the preparation of a beverage. According to embodiments disclosed herein, beverage material may be portioned in a beverage pod for use within a beverage machine without separate disposable packaging for each portion.

A beverage pod may be used to form a beverage such as tea, coffee, espresso, cocoa or other beverages prepared from a beverage material. The beverage material may be suitably prepared coffee beans (e.g. varying roasts, grind sizes, flavorings), tea leaves etc. The beverage material may further include additives such as milk powder, cocoa powder, or sugar. The beverage machine may form such beverages using a base liquid, such as water, that may be combined with the beverage material under suitable conditions to form the beverage.

According to aspects discussed herein, a method of manufacturing a beverage pod may comprise loading successive layers of a beverage material, such as coffee grounds, onto a print bed of a three-dimensional (3-D) printer. A binder is then applied to each of the successive layers of beverage material in a predetermined pattern to bond the beverage material in the predetermined pattern, and the binder may bond the successive layers in the predetermined pattern. The predetermined pattern corresponds to a sequential cross-sectional layer of an object model of the beverage pod where the object model describes sequential cross-sectional layers of the beverage pod designed based on a plurality of different brewing attributes. In some aspects of the invention, the object model may be created using a form of computer aided design and stored in memory to be executed by a processor of a 3-D printer.

In some aspects, the methods and systems may manufacture a beverage pod based on an object model. The geometry of the object model may include a pod having a containment layer of bound beverage material surrounding loose beverage material. In additional embodiments, the pod may also be designed such that the containment layer may be pierceable by a brewing appliance to allow a liquid through one or more pierced openings during brewing, and either filter through the pod or be pierced by one or more exit needles for beverage flow. The containment layer of the pod may be manufactured to have a thickness that enables deformation of the pod during brewing. In other embodiments, the containment layer may be designed to have a thickness that maintains rigidity of the pod during brewing.

In some embodiments, the methods and systems may also include applying a second beverage material. The second beverage material may be a different grind size of the first beverage material. In one embodiment, a smaller grind size may be used for beverage material used to bind a base of the pod to improve structural integrity of the base, where a larger grind size may be used as the primary fill material within the pod. Where different grind sizes are used, they may be easily sifted and separated later when reusing any unbound material in the print process. In other embodiments, a completely different beverage material may be used as a second beverage material to enhance the flavor of the brewed pod. It will also be appreciated that a beverage material may be a combination of different materials (e.g. ground coffee, cocoa powder, milk powder and sugar) integrated into a single beverage material applied to each layer.

In yet additional embodiments, the beverage pod may be designed to have a base and an outer wall that surround one or more beverage ingredients, where the base and the outer wall are made of the one or more beverage ingredients. Examples of beverage ingredients include, but are not limited to: coffee (e.g., coffee grounds, soluble coffee), tea (e.g. tea leaves, dry herbal tea), powdered beverage concentrate, dried fruit extract or powder, powdered or liquid concentrated bouillon or other soup, powdered or liquid medicinal materials (e.g. nutraceuticals), powdered milk or other creamers, sweeteners, thickeners, flavorings, binding agents, coating agents, cellulose, chaff, filter aids, extracts, plant husks, plant fibers, bagasse, additives, or any other type of food.

In some embodiments, the object model may include a bound beverage tablet with built in channels that increase a porosity of the beverage tablet, which may enhance extraction efficiency from the beverage tablet during the brewing process. In other embodiments, the bound beverage tablet may include fault points to facilitate breakage of the pod during brewing.

The inventor has appreciated that, in some situations, brewing attributes, such as the coffee roast (e.g. dark or light), the grind size, or the porosity of the pods or the bound coffee tablets, or the combination of those factors may impact the brew quality. Based on the desired brew attributes, the object model may be modified to vary the dimensional thickness of the pod, or the binder amount to adjust the brew quality. Additionally, different concentrations of binder may be applied to different layers within the beverage pod to alter the porosity of the beverage pod for brewing.

The binder may be a compostable polypropylene or polyethylene based binder fluid. In some embodiments, the binder fluid used may be selected to meet compostability standards such as European standard EN 13432 or American Society for Testing and Materials standard ASTM D6400. EN 13432 requires the compostable material to disintegrate after 12 weeks and completely biodegrade after six months. ASTM D6400 is the recommended compostability test method for a wide range of industrial components and consumer products.

In some embodiments, the binder may include, but is not limited to, cellulose, cellulose derivatives, gelatin, cream, honey, starch, sucrose, mannitol, liquid glucose, wax, zein, a food grade binder, an alginate, edible, soluble, a polysaccharide (such as, but not limited to, sodium alginate), or any other suitable material. In some embodiments, the binder may be a curable binder. In some embodiments, the binder may be used as a coating that serves as a barrier to reduce infiltration of oxygen and/or moisture such as to maintain freshness of the beverage ingredients. The binder may be activated to either cross-link polymers or cure to accelerate the hardening of the binder, and thus the manufacturing of the pod. In some embodiments, the binder may be a compostable organic photocurable binder. The printing system may further include an energy source, such as an Ultraviolet (UV) light source, that may be applied to cure the photocurable binder.

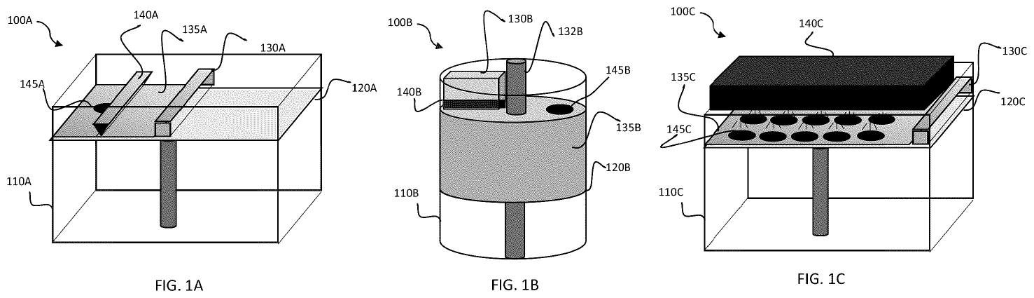

Turning to the figures, illustrative embodiments of various 3-D printing systems and methods used to manufacture beverage pods are shown in FIGS. 1A-4. It should be appreciated that these illustrative embodiments are provided by way of example only, and the inventive aspects herein are not limited to the specific features of these embodiments. Any of the features described above may be applied to any of the illustrative embodiments of the figures as appropriate. Furthermore, any features described in one illustrative embodiment may also be applied to any of the other illustrative embodiments as appropriate.

FIG. 1A shows a 3-D printing system 100A having a build container 110A. Within the build container 110A, a print bed 120A is situated to receive a layer of beverage material 135A that is deposited and spread by a material dispenser 130A. The material dispenser 130A may include or otherwise be connected to a material hopper (not shown) that stores the beverage material that will be used in connection with the build. The material dispenser 130A travels transversely across the length of the print bed 120A, depositing a layer of material 135A on the print bed. In this embodiment, a print head 140A is also configured to travel transversely across the length of the print bed 120A to apply a binder 145A in a predetermined pattern on the material 135A to bond the material in the predetermined patterns. Once the binder 145A has been applied, the print bed 120A is then lowered within the build container 110 so that successive layers of material 135A may be deposited and additional binder 145A may be applied, bonding both the beverage material in the predetermined pattern as well as the beverage material between the successive layers. The layers of the beverage material may be of any thickness, and a layer by itself may not be of uniform thickness, so long as the binder can penetrate the beverage material to bond the material within the predetermined pattern within the layer as well as between successive layers in the pattern.

FIG. 1B illustrates another embodiment of a 3-D printing system 100B that may be used to manufacture a beverage pod. Printing system 100B includes a build container 110B. The build container 110B is cylindrical in shape, having a material dispenser 130B that rotates around an axis 132B that may be housed within the build. In other embodiments, the material dispenser 130B may rotate around an axis suspended above the build container 110B. Similarly, the print head 140B is also configured to rotate above the print bed 120B within the build container 110B. The material dispenser 130B may include or otherwise be connected to a material hopper (not shown) that stores the beverage material that will be used in connection with the build. In this configuration, the material dispenser 130B and the print head 140B may continuously deposit material 135B and apply binder 145B in a uni-directional motion, as the print bed 120B lowers itself in the build container 110B as each layer has been printed.

In yet another embodiment, FIG. 1C illustrates a 3-D printing system 100C having a build container 110C. The printing system 100C has a print bed 120C that receives material 135C from a material dispenser 130C. The material dispenser 130C may include or otherwise be connected to a material hopper (not shown) that stores the beverage material that will be used in connection with the build. In some systems, this 3-D printing system 100C may be designed to print a single type of object (i.e. beverage pods) and not require the ability to vary the print geometry. Therefore, a printhead 140C may be designed as a single stationary component that applies the binder 145C simultaneously along the entire surface of the material 135C. In some embodiments where several different predetermined patterns (e.g. base, wall) are required for each cross-sectional layer of the object, the printhead 140C may be designed to apply different predetermined patterns during the printing process depending on the cross-sectional layer of the object model. Alternatively, in other embodiments, the printing system 100C may have multiple printheads 140C for each pattern that rotate into the position to apply the binder 145C on the print bed 120C. Because the object models are pre-defined for the system printing system 100C, having one or more printheads that can apply binder on the entire print surface with less movement may increase the print speed of the printing system 100C while also decreasing the system cost with fewer moving parts.

It should be appreciated that any description of printing systems described above may include other features not shown. For example, where curable binder is used, the printing system may further include an energy source, such as a UV light source, that may be applied to cure a photocurable binder. Additionally, the systems may be controlled by a processor, either local to the device or remotely.

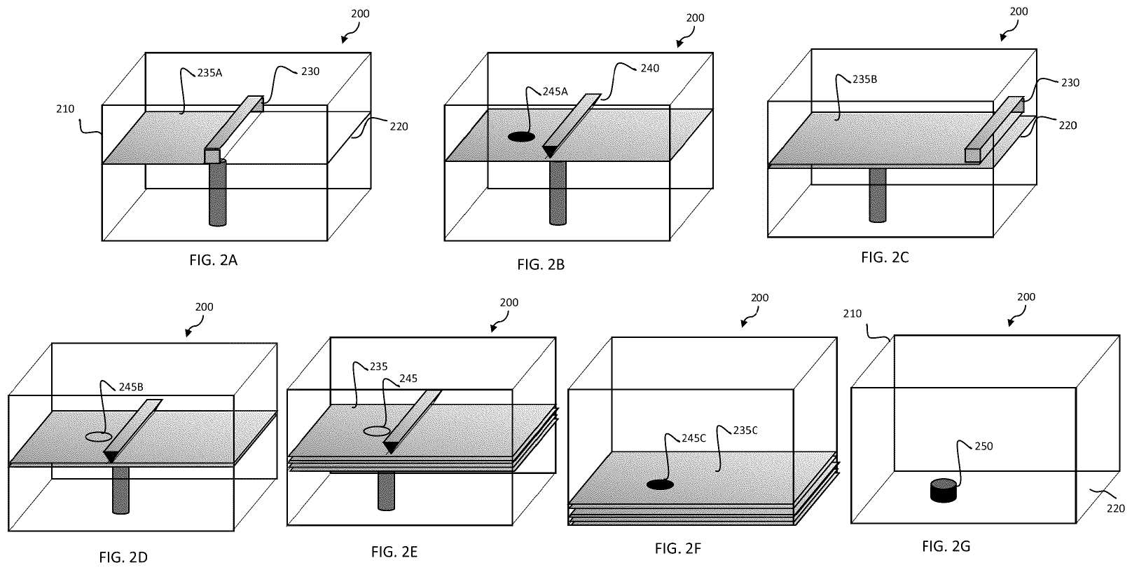

FIGS. 2A-G illustrate exemplary steps in manufacturing a compostable pod in a 3-D printing system. In FIG. 2A, a material dispenser 230 deposits a layer of beverage material 235A on the print bed 220 within the build container 210 of printing system 200. As shown in FIG. 2B, a print head 240 deposits binder 245A in a solid predetermined pattern to build the base of the pod. While the predetermined pattern of the binder 245 in FIG. 2A is circular, it should be appreciated that other shapes are possible. As the binder is applied, the binder may be absorbed between the particles of beverage material, and by the beverage material itself. Once the binder has been deposited, the print bed 220 may be lowered within the build container 210 and a subsequent layer of beverage material 235B may be deposited over that layer as shown in FIG. 2C. The base of the pod may be built by several successive layers of beverage material 235B bound with the same predetermined pattern of binder 245A.

As shown in FIG. 2D, the walls of a pod may be built by applying binder 245B in a predetermined pattern of an outline of the cross-section of the pod, leaving unbound beverage material within the outline. The printing system 200 of FIG. 2E illustrates the printing system 200 after several successive layers of the beverage material 235 have been deposited and binder 245 has been applied to form the walls of the pod. As the printing system 200 applies the binder 245 on the successive layers, the binder 245 bonds the beverage material in the predetermined pattern in each cross-sectional layer, as well as the beverage material between the successive layers. It will be appreciated that as the binder bonds the beverage material both within and between the successive layers, the dimensions of the pod may change. For example, as binder cures, it may contract and pull particles of the beverage material closer together.

Eventually, after the printing system 200 applies binder 245C in a solid predetermined pattern to its final layer of beverage material 235C as shown in FIG. 2F to form the top of the pod, a fully formed pod (not shown) remains within the beverage material in the print bed. FIG. 2G shows the de-powdered build container 210 with a completed beverage pod 250 remaining on the print bed 220. In some embodiments, the beverage pod 250 may contain unbound beverage material encapsulated within a containment layer comprising beverage material and binder.

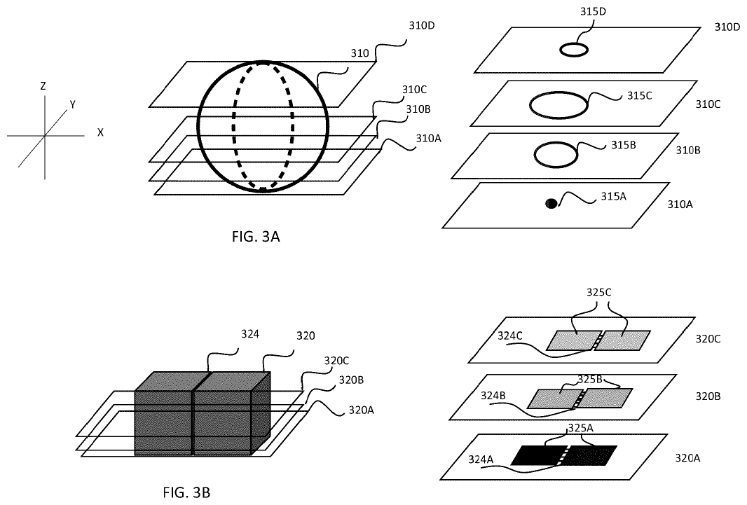

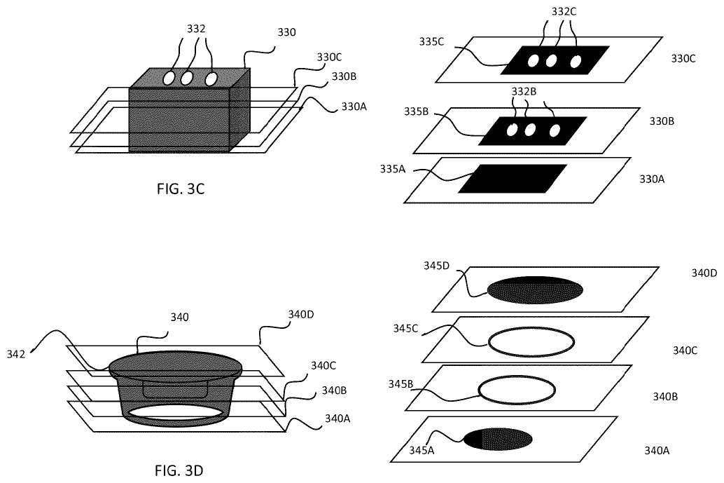

FIGS. 3A-D are various embodiments of beverage pods that may be manufactured in a 3-D printing system, including those of FIGS. 1A-C. Although FIGS. 3A-D illustrate several different beverage pod shapes, it will be appreciated that a beverage pod can be of any shape, such as a cuboid, cube, cylinder, elliptic cylinder, frustoconical, and/or a sphere. With respect to FIGS. 3A-D, an object model of a beverage pod is a representation of the pod comprising a number of cross-sectional layers of the pod or “slices” in the xy plane along the z-axis. The various beverage pods shown in FIGS. 3A-D include a selection of example cross-sectional layers of each pod.

FIG. 3A is an embodiment of a beverage pod 310 having a spherical shape. Views of cross-sectional layers 310A-D show example layers of the beverage pod 310 with a predetermined pattern on each layer of an object model of the beverage pod. On layer 310A, close to the base of the beverage pod 310, the predetermined pattern 315A is circular, having a small circumference relative to the widest circumference of the pod 310. Additionally, the predetermined pattern 315A is completely filled. On layer 310B, which is higher up on the z-axis from layer 310A, the predetermined pattern 315B provides a boundary of the pod 310 having a wider circumference than 315A. Layer 310C approaches the cross-section of the spherical pod 310 at its diameter, providing a wider predetermined pattern 315C. As the cross-sections get higher along the pod, past the circumference of the pod along the z-axis, the predetermined pattern 315D gets smaller once again as illustrated in layer 310D. An object model of the pod 310 may be designed to provide certain structural components to the pod 310, including the thickness of the boundary of the pod 310.

FIG. 3B is another embodiment of a beverage pod 320 illustrating views of cross-sectional layers 320A-C for printing. The beverage pod 320 is cuboid shaped. The object model of beverage pod 320 may provide a block of coffee grounds designed with a fault line 324. The fault line 324 may be designed into the object model of the beverage pod 320 to facilitate the breakage of the pod into two or more sections. As mentioned previously, the design of the object model may depend on the desired brewing attributes, including the geometry, beverage material grind size, the coffee roast type, and intended brew parameters of a single serve coffee brewing appliance.

As illustrated in layer 320A, binder 325A may be applied in a higher concentration along the entire bottom layer as well as the outer edges of the beverage pod 320 to maintain structural integrity that may be required for packaging and transportation of the beverage pods in the supply chain. The fault line 324 may be constructed by providing a lighter application of binder and/or a series of connecting bridge elements 324A that may be more easily broken. Higher up the z-axis, in layers 320B and 320C, the binder application 325B and 325C, respectively, may be a lighter concentration of binder (or no binder for loose beverage material) based on the desired brewing attributes. Again, the fault line 324 may be constructed in these layers 320B and 320C by providing a lighter application of binder and/or a series of connecting bridge elements 324B and 324C. Depending on the desired breakage resistance, in some embodiments, the bridge elements may be omitted in selected layers.

FIG. 3C is yet another embodiment of a beverage pod 330 with views of select cross-sectional layers 330A-C. The object model of beverage pod 330 may be designed with openings 332 that may function as interaction points with a brewing appliance. As illustrated in layer 330A, binder 335A may be applied in a higher concentration along the entire base of the beverage pod 330. The openings 332 may be created by applying binder 335B in a pattern having an unbound region 332B and binder 335C in a pattern having an unbound region 332C in subsequent layers 330B and 330C respectively. It should be appreciated that in some embodiments, the object model may be designed in a manner to provide internal channels (not shown) within the beverage pod 330 to allow for liquid flow into the body of the beverage pod 330. In some embodiments, those channels may lead to exit openings within a pod surface, including surface areas within filter-like openings that allow the brewed beverage to leave the beverage pod, while preventing or at least hindering passage of coffee grounds out of the beverage pod.

FIG. 3D illustrates another embodiment of a beverage pod 340 having a frustoconical shape, including a base and a top surface having a lip 342 that may engage with a pod receptacle or housing within a brewing appliance. The object model of the beverage pod 340 includes a solid base as shown in layer 340A having binder 345A applied in a solid circular pattern. As shown with respect to layers 340B and 340C, the walls of the beverage pod 340 may be constructed by applying binder 345B and 345C in an open circular pattern, with the patterns gradually increasing in circumference as the cross-sectional layers are viewed along the positive z-axis. The open circular pattern allows the layered beverage material to remain unbound as the walls of the beverage pod are gradually built up. Finally, the top of the beverage pod may be printed with solid circular patterns on the top successive layers in the build as shown in layer 340D and the applied binder 345D.

Since the beverage pod 340 of FIG. 3D is constructed with a composite of beverage material and binder for its base, walls and top, the beverage pod comprises a container that defines an interior space filled with the beverage material. The beverage pod 340 may be designed to interact with liquid introduced into the container to form a beverage. In some embodiments, the beverage pod may include openings in a surface (e.g. the base, top, or walls) to permit brewed beverage to exit the interior space of the container. In some embodiments, the beverage pod 340 may be designed with the top having an appropriate thickness and pliability to be pierced by a puncture needle of a beverage appliance, without breaking the remainder of the top. Further, the openings in the surface may serve as a filter that obstructs beverage material from exiting the container during outflow of beverage from the container.

In some embodiments, the object model of a beverage pod 340 may include an extension that prevents a piercing element of a beverage appliance from piercing the container. For example, rather than apply the binder as a solid circular pattern at the base of the beverage pod, a first number of layers at the base may apply binder in an open circle pattern to create a void at the bottom prior to building the solid base such that a puncture needle will not extend into the solid base as the beverage pod sits within the pod receptacle within the brewing appliance.

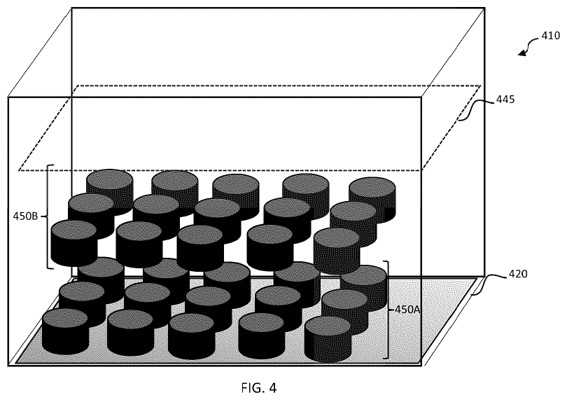

FIG. 4 shows how a number of beverage pods 450A, 450B may be manufactured within a single build container 410 for mass production. It will be appreciated that within a build container 410, the print bed 420 may hold a first plurality of beverage pods 450A on a single print bed 420. It will be further appreciated that as the subsequent layers of beverage material are deposited within the build container 410 and beverage pods 450A are completed, a second plurality of pods 450B may be manufactured on additional layers such that the volume of the build container 410 includes multiple layers of beverage pods. The build container 410 of FIG. 4 shows multiple layers of beverage material up to layer 445 (shown in broken lines). The build instructions for the pods may be designed to maximize the number of beverage pods for efficient use of the print volume in the build container 410, including for example, printing certain pods with base side up.

The embodiments disclosed herein may be combined in any suitable arrangement as the disclosure is not limited in this regard. While the present teachings have been described in conjunction with various embodiments and examples, it is not intended that the present teachings be limited to such embodiments or examples. On the contrary, the present teachings encompass various alternatives, modifications, or equivalents, as will be appreciated by those of skill in the art. Accordingly, the foregoing description is by way of example only.

What is claimed is:

1. A method of manufacturing a beverage pod, the method comprising:
loading successive layers of a beverage material onto a print bed of a three-dimensional (3D) printer; and
applying binder to each of the successive layers of the beverage material in a predetermined pattern to bond the beverage material in the predetermined pattern, and the binder bonding the successive layers in the predetermined pattern,
wherein the predetermined pattern corresponds to a sequential cross-sectional layer of an object model for a beverage pod where the object model describes sequential cross-sectional layers of the beverage pod designed based on a plurality of different brewing attributes.

2. The method of claim 1, wherein the beverage material is ground coffee.

3. The method of claim 2, wherein the plurality of different brewing attributes includes at least one of geometry and beverage material grind size.

4. The method of claim 2, wherein loading a layer of beverage material comprises loading beverage material of a first grind size or a second grind size as determined by the brewing attributes of the beverage pod.

5. The method of claim 1, wherein the object model includes filters, solid pattern, enclosure, and loose beverage material contained within the enclosure.

6. The method of claim 1, wherein the geometry of the object model includes a pod having a containment layer of bound beverage material surrounding loose beverage material.

7. The method of claim 6, wherein the geometry of the object model further includes a plurality of openings in the containment layer that allows a liquid to filter through the plurality of openings during brewing.

8. The method of claim 6, wherein the containment layer has a thickness that enables deformation of the pod during brewing.

9. The method of claim 6, wherein the containment layer has a thickness that maintains rigidity of the pod during brewing.

10. The method of claim 1, wherein the geometry of the object model includes a pod of solid bound beverage material.

11. The method of claim 10, wherein the geometry of the object model further includes fault points to facilitate breakage of the pod during brewing.

12. The method of claim 1, wherein the binder is a biodegradable liquid binder.

13. The method of claim 1, wherein the binder is a curable binder and wherein forming at least one beverage pod further comprises curing the binder with an energy source after applying the binder.

14. The method of claim 13, wherein the curable binder is a photocurable binder.

15. The method of claim 14, wherein the energy source is an ultraviolet light source.

16. A three-dimensional (3D) printing system for manufacturing a brewable beverage pod, the system comprising:
a print bed;
a material cartridge configured to hold a beverage material;
a dispenser configured to load a layer of the beverage material from the material cartridge on the print bed;
a print head configured to apply a binder to the layer of the beverage material; and
a controller configured to control the print head to apply the binder in predetermined pattern.

17. The system of claim 16, further comprising a second material cartridge configured to hold a second beverage material and a dispenser configured to load a layer of the second beverage material on the print bed.

18. The system of claim 16, further comprising an energy source configured to cure the binder.

19. The system of claim 18, further wherein the energy source is a UV light source.

20. A compostable beverage pod comprising:
a container defining an interior space, the container made from a composite of a beverage material and a binder;
a beverage medium in the interior space, the beverage medium being configured to interact with liquid introduced into the container to form a beverage, the beverage medium made from at least the beverage material; and
where the container further includes openings on a surface of the container to permit a beverage to exit the interior space.

21. The compostable beverage pod of claim 20, wherein the openings on the surface serve as a filter that obstructs the beverage medium from exiting the container.

22. The compostable beverage pod of claim 20, wherein the openings on the surface are located within a base of the container, and the base further includes an extension that prevents a piercing element of a beverage appliance from piercing the container.
